(19) United States
(12) Patent Application Publication
(10) Pub. No.: US 2012/0298463 A1
(43) Pub. Date: Nov. 29, 2012

(54) WET TYPE MULTI-PLATE FRICTION CLUTCH

(76) Inventors: Jun Tokumasu, Hamamatsu-shi (JP); Shouhei Tominaga, Hamamatsu-shi (JP)

(21) Appl. No.: 13/261,325

(22) PCT Filed: Dec. 9, 2010
(86) PCT No.: PCT/JP2010/072164

§ 371 Date: Aug. 3, 2012

(30) Foreign Application Priority Data
Dec. 17, 2009 (JP) 2009-286432

(51) Int. Cl. F16D 13/74

(52) U.S. Cl. 192/66.3

(57) ABSTRACT

A clutch which can realize further reduction of drag torque, a method for reducing the drag torque of the clutch, and a clutch friction plate used in the clutch are provided. In a clutch 100, clutch plates 103 and clutch friction plates 110, both of which are flat and annular, are alternatingly arranged, and clutch oil is supplied to spaces between the clutch plates 103 and the clutch friction plate 110. Each clutch friction plate 100 has small-groove groups 113 and fan-shaped grooves 114 formed on a surface of a metal core 111, which is flat and annular. Each small-groove group 113 includes a plurality of small grooves 113a which are parallel to one another and extend from the inner peripheral side to the outer peripheral side of the metal core 111. Each fan-shaped groove 114 is formed adjacent to the corresponding small-groove group 113 such that its width increases from the inner peripheral side toward the outer peripheral side of the metal core 111. When the clutch friction plates 110 rotate, the clutch 100 leads the clutch oil present at the inner peripheral side of the metal core 111 to the outer peripheral side of the metal core 111 through the small-groove groups 113 and the fan-shaped grooves 114.

### TECHNICAL FIELD

The present invention relates to a clutch which has reduced drag torque generated between clutch friction plates and clutch plates that are pressed against one another or separated from one another in order to transfer force from a prime mover to a driven body or cut off the transfer, a method for reducing the drag torque of the clutch, and a clutch friction plate used in the clutch.

### BACKGROUND ART

In general, a vehicle, such as a four-wheel car or a two-wheel vehicle, uses a clutch in order to transfer drive force from a prime mover, such as an engine, to a driven body, such as a wheel. The clutch transfers drive force from the prime mover to the driven body or cuts off the transfer by pressing flat annular clutch plates against flat annular clutch friction plates driven and rotated by the prime mover or separating the clutch plates from the clutch friction plates. On one surface of each clutch friction plate of the clutch, which surface faces the corresponding clutch plate, a plurality of small frictional sheets are bonded in the circumferential direction thereof in order to increase the frictional force between the clutch friction plate and the corresponding clutch plate. Oil grooves are formed by the spacings between the plurality of frictional sheets. The oil grooves serve as flow channels for clutch oil to be supplied to spaces between the clutch friction plates and the clutch plates in order to absorb frictional heat generated between the frictional sheets and the clutch plates and prevent wear of the frictional sheets.

Such a clutch is always required to reduce so-called drag torque in order to improve the fuel consumption of a vehicle in which the clutch is installed. Drag torque is torque which is transferred, by means of viscous resistance of the clutch oil, between the clutch friction plates and the clutch plates when they are separated from each other, because of the difference in rotational speed between the clutch friction plates and the clutch plates. Drag torque is one cause of an increase in the fuel consumption of a vehicle.

Therefore, Patent Document 1 discloses a clutch friction plate in which one or both of the outer corners of small frictional sheets provided on the surface of the clutch friction plate are rounded (curved) or chamfered so as to reduce drag torque.

### PRIOR ART DOCUMENTS

### Patent Documents

Patent Document 1: Japanese Patent Application Laid-Open (kokai) No. 2009-68689

However, a so-called wet-type multi-plate friction clutch which contains clutch oil between clutch friction plates and clutch plates is always required to reduce drag torque produced between the clutch friction plates and the clutch plates, and the above-described conventional technique is not satisfactory.

The present invention was accomplished in order to solve the above-described problem, and its object is to provide a clutch which can realize a further reduction of drag torque, a method for reducing the drag torque of the clutch, and a clutch friction plate used in the clutch.

### SUMMARY OF THE INVENTION

In order to achieve the above-described object, there is provided a clutch recited in claim 1, which comprises a clutch friction plate having a plurality of frictional sheets and a plurality of oil grooves provided on a surface of a flat annular metal core, the oil grooves being formed by spacings between the frictional sheets and extending from the inner peripheral side to the outer peripheral side of the metal core; a flat annular clutch plate which is pressed against or separated from the frictional sheets of the clutch friction plate; and clutch oil supplied to a space between the clutch friction plate and the clutch plate. The clutch is characterized in that the oil grooves include small-groove groups composed of a plurality of small grooves having a width smaller than the width of the frictional sheets measured in the circumferential direction of the metal core, and fan-shaped grooves each disposed adjacent to the corresponding small-groove group in the circumferential direction of the metal core and formed such that the width of the fan-shaped grooves increases from the inner peripheral side toward the outer peripheral side of the metal core; and in that when the clutch friction plate rotates, the clutch oil present at the inner peripheral side of the metal core is led to the outer peripheral side of the metal core through the small-groove groups and the fan-shaped grooves so as to reduce drag torque produced between the clutch friction plate and the clutch plate.

According to the feature of the present invention recited in claim 1, a clutch including a clutch friction plate, a clutch plate, and clutch oil is configured such that small-groove groups and fan-shaped grooves are provided on a surface of a flat annular metal core of the clutch friction plate, wherein each of the small-groove groups includes a plurality of small grooves having a width smaller than the width of the frictional sheets measured in the circumferential direction of the metal core, and each of the fan-shaped grooves is disposed adjacent to the corresponding small-groove group in the circumferential direction of the metal core and formed such that the width of the fan-shaped grooves increases from the inner peripheral side toward the outer peripheral side of the metal core. When the clutch friction plate rotates, the clutch leads the clutch oil present at the inner peripheral side of the metal core to the outer peripheral side of the metal core through the small-groove groups and the fan-shaped grooves. The present inventors found through an experiment that the above-described structure can further reduce drag torque compared with a conventional technique, i.e., with a clutch which uses a conventional clutch friction plate in which the outer corner portions of the small frictional sheets provided on the surface of the clutch friction plate are rounded (curved) or chamfered.

Another feature of the present invention recited in claim 2 resides in the number of the small-groove groups provided in the circumferential direction of the metal core being 5 to 10, and in the number of the fan-shaped grooves provided in the circumferential direction of the metal core being 5 to 10.

According to the feature of the present invention recited in claim 2, five to ten small-groove groups and five to ten fan-shaped grooves are formed on the surface of the metal core of the clutch friction plate. The present inventors found through an experiment that the above-described structure can further reduce drag torque compared with the case where the number of the small-groove groups provided on the surface of the metal core of the clutch friction plate is 4 or less or 11 or greater, and the number of the fan-shaped grooves provided on the surface of the metal core is 4 or less or 11 or greater.

Another feature of the present invention recited in claim 3 resides in the number of the small grooves of each small-groove group being 4 to 6.

According to the feature of the present invention recited in claim 3, the number of the small grooves of each small-groove group is 4 to 6. The present inventors found through an experiment that the above-described structure can further reduce drag torque compared with the case where the number of the small grooves of each small-groove group is 3 or less or 7 or greater.

Another feature of the present invention recited in claim 4 resides in end portions of the small grooves located on the inner peripheral side of the metal core being staggered such that the end portions of small grooves adjacent to each other are shifted from each other in the radial direction of the metal core.

According to the feature of the present invention recited in claim 4, the end portions of the small grooves of each small-groove group located on the inner peripheral side of the metal core are staggered such that the end portions of small grooves adjacent to each other are shifted from each other in the radial direction of the metal core. The present inventors found through an experiment that the above-described structure can further reduce drag torque compared with the case where the end portions of the small grooves of each small-groove group located on the inner peripheral side of the metal core are aligned in the radial direction of the metal core.

The present invention can be implemented not only in the form of a clutch, but also in the form of a method of reducing the drag torque of the clutch, and in the form of a clutch friction plate used in the clutch.

### BRIEF DESCRIPTION OF THE DRAWINGS

FIG. 1 is a Sectional view showing the overall structure of a clutch according to one embodiment of the present invention.

FIG. 2 is a plan view schematically showing the exterior of a clutch friction plate of the clutch shown in FIG. 1.

FIG. 3 is a graph showing a drag torque increase or decrease ratio attained using the clutch friction plate shown in FIG. 2 compared with those attained using conventional clutch friction plates.

FIG. 4 is a plan view schematically showing the exterior of a conventional clutch friction plate.

FIG. 5 is a plan view schematically showing the exterior of another conventional clutch friction plate.

FIG. 6 is a plan view schematically showing the exterior of another conventional clutch friction plate.

FIG. 7 is a graph showing the drag torque increase or decrease ratio attained using the clutch friction plate shown in FIG. 2, compared with that attained using a conventional clutch friction plate and that attained using a clutch friction plate having no small groove in order to demonstrate the usefulness of the small grooves provided on the clutch friction plate shown in FIG. 2.

FIG. 8 is a plan view schematically showing the exterior of the clutch friction plate having no small groove.

FIG. 9 is a plan view schematically showing the exterior of a clutch friction plate according to a modification of the present invention.

FIG. 10 is a graph showing drag torque increase or decrease ratios respectively attained using three different clutch friction plates which differ in the number of oil grooves provided on a metal core, compared with that attained using a conventional clutch friction plate in order to demonstrate the relation between drag torque and the number of oil grooves.

FIG. 11 is a plan view schematically showing the exterior of a clutch friction plate according to another modification of the present invention.

FIG. 12 is a plan view schematically showing the exterior of a clutch friction plate according to another modification of the present invention.

FIG. 13 is a graph showing drag torque increase or decrease ratios respectively attained using four different clutch friction plates which differ in the number of small grooves in each small-groove group, compared with that attained using a conventional clutch friction plate in order to demonstrate the relation between drag torque and the number of small grooves in each small-groove group.

FIG. 14 is a plan view schematically showing the exterior of a clutch friction plate according to another modification of the present invention.

FIG. 15 is a plan view schematically showing the exterior of a clutch friction plate according to another modification of the present invention.

FIG. 16 is a plan view schematically showing the exterior of a clutch friction plate according to another modification of the present invention.

FIG. 17 is a graph showing drag torque increase or decrease ratios respectively attained using four different clutch friction plates which are similar in the total area of the frictional sheets, compared with that attained using a conventional clutch friction plate in order to demonstrate the relation between drag torque and the total area of the frictional sheets.

FIG. 18 is a graph showing drag torque increase or decrease ratios respectively attained using a clutch friction plate in which end portions of adjacent frictional sheets located on the inner peripheral side of the metal core are aligned with each other and a clutch friction plate in which end portions of adjacent frictional sheets located on the inner peripheral side of the metal core are shifted from each other, compared with that attained using a conventional clutch friction plate in order to demonstrate the relation between drag torque and the positions of the end portions of adjacent frictional sheets located on the inner peripheral side of the metal core.

FIG. 19 is a plan view schematically showing the exterior of a clutch friction plate according to another modification of the present invention.

### MODE FOR CARRYING OUT THE INVENTION

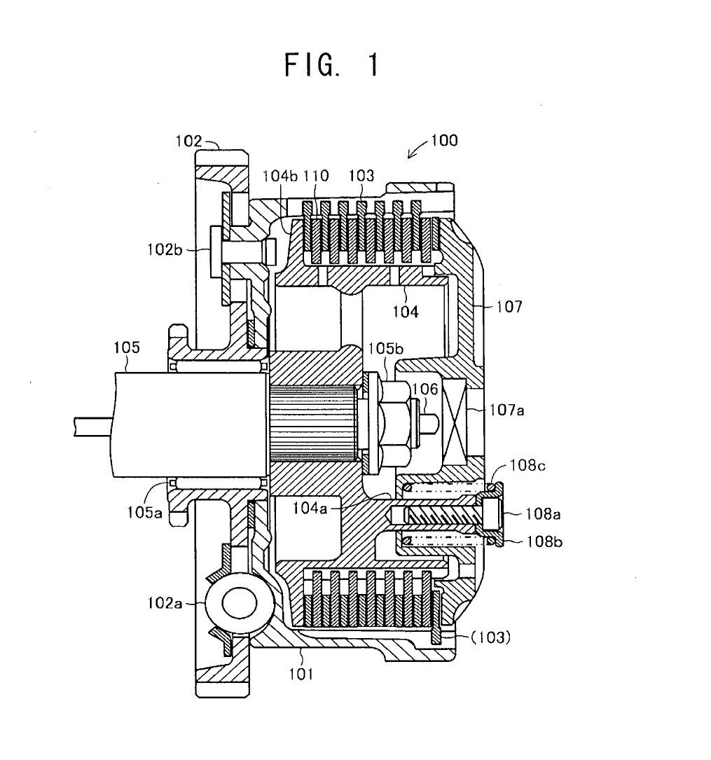

One embodiment of a clutch according to the present invention will now be described with reference to the drawings. FIG. 1 is a sectional view showing the overall structure of a clutch 100 according to the present invention. In each of the drawings which will be referred to herein, some components are shown schematically, such as in an exaggerated manner so as to facilitate the understanding of the present invention. Therefore, the dimensions, dimensional ratios, etc. of the constituent elements may differ from the actual dimensions, dimensional ratios, etc. The clutch 100 is a mechanical device for transferring drive torque from an engine (not shown), which is the prime mover of a two-wheel vehicle (motorcycle), to a wheel (not shown), which is a driven body, and stopping the transfer of the drive torque. The clutch 100 is disposed between the engine and a transmission (not shown).

### (Structure of the Clutch 100)

The clutch 100 has a housing 101 formed of an aluminum alloy. The housing 101 is a member which is formed into the shape of a cylindrical tube with a bottom and which partially constitutes the enclosure of the clutch 100. An input gear 102 is fixed, through a torque damper 102a, to the left-hand side surface of the housing 101 as viewed in FIG. 1 by means of rivets 102b. The input gear 102 is in engagement with an unillustrated drive gear which is driven and rotated by an engine. Thus, the input gear 102 is driven and rotated by the drive gear. A plurality (8 in the present embodiment) of clutch plates 103 are held on the inner circumferential surface of the housing 101 through spline engagement so that the clutch plates 103 can move in the axial direction of the housing 101 and can rotate together with the housing 101.

The clutch plates 103 are flat annular members which are pressed against clutch friction plates 110, which will be described later. The clutch plates 103 are formed by punching a thin SPCC (cold-rolled steel plate) into an annular shape. Unillustrated oil grooves having a depth of several μm to several tens of μm are formed on opposite side surfaces (the front and back surfaces) of each clutch plate 103 so as to retain clutch oil, which will be described later. Surface hardening treatment is performed on the opposite side surfaces (the front and back surfaces) of each clutch plate 103 on which the oil grooves are formed in order to enhance wear resistance. Since this surface hardening treatment does not directly relate to the present invention, it will not be described here.

A friction plate holder 104 having a generally cylindrical shape is disposed inside the housing 101 concentrically with the housing 101. A large number of spline grooves extending in the axial direction of the friction plate holder 104 are formed on the inner circumferential surface of the friction plate holder 104. A shaft 105 is spline-engaged with the spline grooves. One end portion (the right end portion in FIG. 1) of the shaft 105, which is hollow at the center, rotatably supports the input gear 102 and the housing 101 through a needle bearing 105a, and fixedly supports, through a nut 105b, the friction plate holder 104 which is frictionally engaged with that end portion. Thus, the friction plate holder 104 rotates together with the shaft 105. The opposite end portion (the left end portion in FIG. 1) of the shaft 105 is connected to the unillustrated transmission of the two-wheel vehicle.

A push rod 106 extends through the hollow space of the shaft 105 and projects from one end (the right end in FIG. 1) of the shaft 105. The end (the left end in FIG. 1) of the push rod 106 opposite the end portion thereof projecting from the one end portion (the right end portion in FIG. 1) of the shaft 105 is connected to an unillustrated clutch operating lever of the two-wheel vehicle. Therefore, when the clutch operating lever is operated, the push rod 106 slides within the hollow space of the shaft 105 in the axial direction of the shaft 105.

A plurality (7 in the present embodiment) of clutch friction plates 110 are held on the outer circumferential surface of the friction plate holder 104 by spline engagement such that the clutch friction plates 110 and the clutch plates 103 are alternatingly arranged, and such that the clutch friction plates 110 can move in the axial direction of the friction plate holder 104 and can rotate together with the friction plate holder 104.

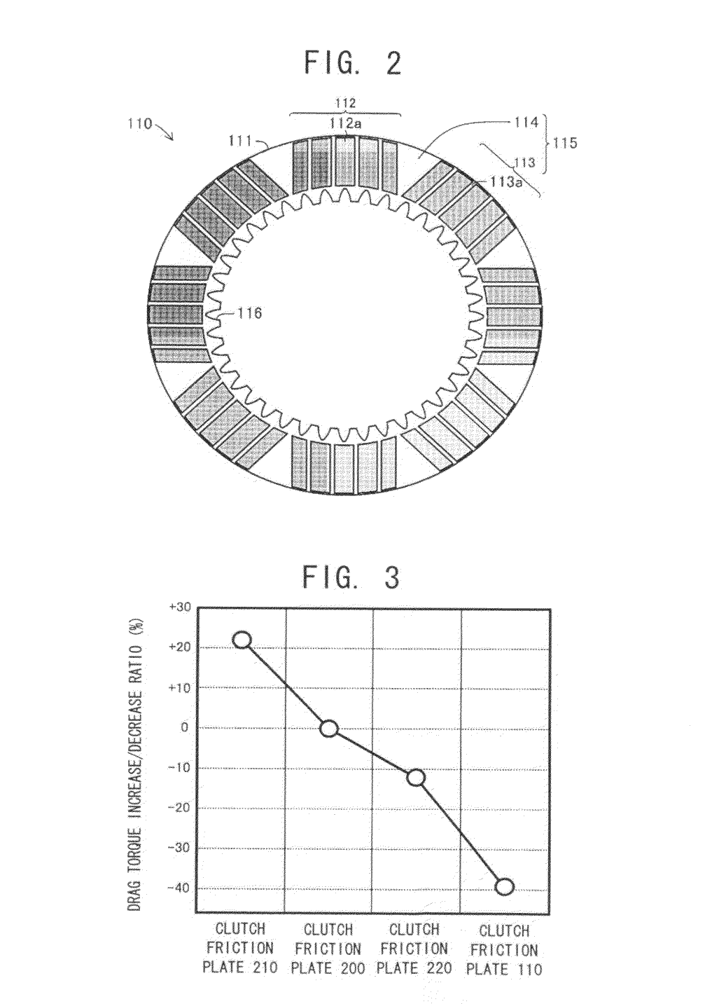

As specifically shown in FIG. 2, each clutch friction plate 110 has frictional sheets 112a and oil grooves 115 provided on a flat annular metal core 111. The metal core 111 is a member which serves as the base of the clutch friction plate 110, and it is formed by punching a thin SPCC (cold-rolled steel plate) into a generally annular shape. The clutch friction plate 110 has friction sheet groups 112 and oil grooves 115 provided on a side surface thereof facing the corresponding clutch plate 103, i.e., on a side surface of the metal core 111 facing the clutch plate 103. Each of the friction sheet groups 112 is composed of a plurality of small frictional sheets 112a. The oil grooves 115 are formed by the frictional sheets 112a. In FIG. 2, the frictional sheets 112a are hatched (this applies to other drawings as well).

The frictional sheets 112a, which produce an increased frictional force in cooperation with the corresponding clutch plate 103, are formed by cutting a sheet of paper into a generally rectangular shape having long sides with a length corresponding to the width of an annular portion of the metal core 111 measured in the radial direction. Each friction sheet group 112 is formed by five frictional sheets 112a, which extend from the inner peripheral side toward the outer peripheral side of the metal core 111 and which are arranged in parallel with one another at predetermined intervals. The spacing between adjacent frictional sheets 112a arranged in parallel has a width smaller than the width of the frictional sheets 112a measured in the circumferential direction of the metal core 111. In other words, a single small groove 113a is formed by two frictional sheets 112a adjacent to each other. That is, each friction sheet group 112 is provided with a single small-groove group 113 which includes four small grooves 113a formed by five frictional sheets 112a.

Eight friction sheet groups 112 are disposed at equal intervals in the circumferential direction of the metal core 111 with predetermined spacings formed between them. Thus, on the surface of the metal core 111, the friction sheet groups 112 are disposed approximately radially, and eight fan-shaped grooves 114 having a width which increases from the inner side toward the outer side of the metal core 111 are formed by the friction sheet groups 112. In this case, the spacing between two adjacent friction sheet groups 112 at the innermost portion of the metal core 111, i.e., the width of each fan-shaped groove 114 at the radially innermost position, is approximately equal to the spacing between the frictional sheets 112a of each friction sheet group 112 (in other words, the width of the small grooves 113a). Each of the above-mentioned oil grooves 115 is composed of one small-groove group 113 and one fan-shaped groove 114.

The metal core 111 has a spline 116 (internal teeth) which is formed along the inner circumference thereof for spline engagement with the friction plate holder 104. The frictional sheets 112a are bonded onto the metal core 111 by adhesive. The frictional sheets 112a may be formed of a material other than paper, such as cork, rubber, or glass, as long as the selected material can increase the frictional force between the clutch friction plates 110 and the clutch plates 103.

A predetermined amount of clutch oil (not shown) is charged into the interior of the friction plate holder 104, where three tubular support columns 104a are formed (FIG. 1 shows one of them). The clutch oil is supplied to the spaces between the clutch friction plates 110 and the clutch plates 103 so as to absorb frictional heat generated between the clutch friction plates 110 and the clutch plates 103 and prevent wear of the frictional sheets 112a. Thus, this clutch 100 is a so-called a wet-type multi-plate friction clutch. The three tubular support columns 104a project from the friction plate holder 104 to the outside in the axial direction of the friction plate holder 104 (the right-hand side in FIG. 1). A pressing force-applying cover 107, which is disposed concentrically with the friction plate holder 104, is fixed to the tubular support columns 104a via bolts 108a, support plates 108b, and coil springs 108c. The pressing force-applying cover 107 assumes the form of a generally circular disc having an outer diameter approximately equal to that of the clutch friction plates 110. The coil springs 108c press the pressing force-applying cover 107 toward the friction plate holder 104. A release bearing 107a which faces the distal end of the push rod 106 located on the right-hand side in FIG. 1 is provided at the center of the pressing force-applying cover 107.

### (Operation of the Clutch 100)

Next, operation of the clutch 100 having the above-described structure will be described. As described above, the clutch 100 is disposed between the engine and the transmission of a vehicle. In accordance with operation of the clutch operating lever by an operator of the vehicle, the clutch transfers drive force from the engine to the transmission or stops the transfer.

That is, when the operator of the vehicle retracts the push rod 106 (moves the push rod 106 to the left in FIG. 1) by operating the clutch lever (not shown), the distal end of the push rod 106 is disengaged from the release bearing 107a. As a result, by virtue of the elastic force of the coil springs 108c, the pressing force-applying cover 107 presses the clutch plates 103. Thus, the clutch plates 103 and the clutch friction plates 110 are pressed against one another while moving toward a support flange 104b formed on the outer circumferential surface of the friction plate holder 104, whereby the clutch plates 103 and the clutch friction plates 110 are frictionally coupled together. As a result, the drive force transmitted from the engine to the input gear 102 is transferred to the transmission via the clutch plates 103, the clutch friction plates 110, the friction plate holder 104, and the shaft 105.

When the operator of the vehicle advances the push rod 106 (moves the push rod 106 to the right in FIG. 1) by operating the clutch lever (not shown), the distal end of the push rod 106 pushes the release bearing 107a. As a result, the pressing force-applying cover 107 moves rightward in FIG. 1 against the elastic force of the coil springs 108c, i.e., it moves away from the clutch plate 103. Thus, the clutch plates 103 and the clutch friction plates 110 are released from a state in which they are pressed and coupled together while moving toward the pressing force-applying cover 107, whereby the clutch plates 103 and the clutch friction plates 110 are disengaged from one another. Consequently, the transfer of drive force from the clutch plates 103 to the clutch friction plates 110 is stopped, whereby the drive force transmitted from the engine to the input gear 102 is prevented from being transferred to the transmission.

While the clutch friction plates 110 rotate in a state in which the clutch friction plates 110 and the clutch plates 103 are pressed together or in which they are separated from one another, the clutch oil present at the inner peripheral side of the clutch friction plates 110 flows toward the outer peripheral side of the clutch friction plate 110 because of centrifugal force generated as a result of rotation of the clutch friction plates 110. In this case, the clutch oil present at the inner peripheral side of the clutch friction plates 110 is led to the outer peripheral side of the clutch friction plates 110 through the small grooves 113a and the fan-shaped grooves 113b of the clutch friction plates 110. By an experiment, the present inventors confirmed that drag torque can be reduced compared with the case where conventional clutch friction plates are used.

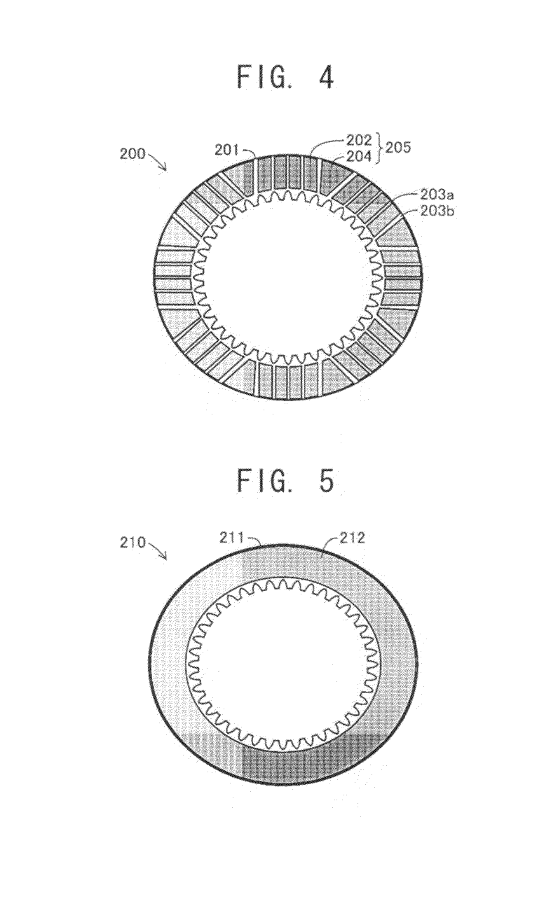

FIG. 3 is a graph showing the results of the experiment carried out by the present inventors. The graph shows the ratio of the increase or decrease in drag torque (Nm) in each of the cases where the clutch friction plates 110 of the present invention and conventional clutch friction plates 210 and 220 were used. In the graph, the drag torque produced in the case where conventional clutch friction plates 200 were used is shown as a reference. As shown in FIG. 4, clutch friction plates 200 are configured such that eight friction sheet groups 205 are arranged in the circumferential direction of a metal core 201. Each friction sheet group 205 is composed of four rectangular frictional sheets 202 which are disposed in parallel on the metal core 201 with oil grooves 203a formed therebetween, and a generally triangular frictional sheet 204 provided on the metal core 201 adjacent to the four frictional sheets 202 with an oil groove 203b formed therebetween.

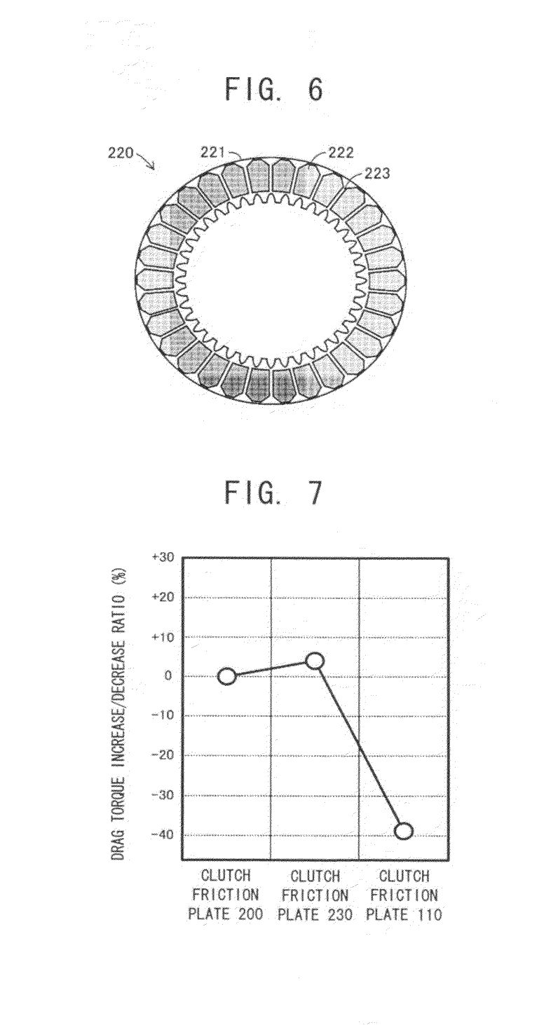

As shown in FIG. 5, clutch friction plates 210 are configured such that an annular frictional sheet 212 is provided over the entire metal core 211 without formation of oil grooves. As shown in FIG. 6, clutch friction plates 220 are configured such that 30 frictional sheets 222 having a generally hexagonal shape are radially arranged in the circumferential direction of a metal core 221 with oil grooves 223 formed therebetween. Two corners of each frictional sheet 222 located on the outer peripheral side of the metal core 221 are chamfered.

The results of the experiment shown in FIG. 3 demonstrate that the clutch friction plate 110 of the present invention can reduce drag torque by about 40% compared with clutch friction plate 200 (reference). The drag torque decrease ratio of the clutch friction plate 110 is quite large compared with that of clutch friction plate 220 having the chamfered frictional sheets 222 (about 12%).

It has been known that, in general, the magnitude of the drag torque produced between a clutch friction plate and a clutch plate depends on the total area of the frictional sheets provided on the clutch friction plate. That is, the drag torque decreases with the total area of the frictional sheets provided on the clutch friction plate. In the results of the experiment shown in FIG. 3, if the total area of the frictional sheets 202 of clutch friction plate 200 is considered to be 1, the total area of the frictional sheets 222 of clutch friction plate 220 is 0.95, and the total area of the frictional sheets 112a of the clutch friction plate 110 is 0.85.

That is, the results of the experiment shown in FIG. 3 demonstrate that the magnitude of the drag torque changes depending not only on the total area of the frictional sheets provided on each clutch friction plate, but also on the shape and positions of the frictional sheets and the shape and positions of the oil grooves, which are defined by the shape and positions of the frictional sheets. The clutch friction plate 110 of the present invention is characterized in that a large reduction in drag torque which is greater than that corresponding to a decrease in area (the total area of the frictional sheets) compared to the conventional clutch friction plates 200 and 220 is realized by appropriately determining the shape and positions of the frictional sheets 112a and the shape and positions of the oil grooves 113, which are defined by the shape and positions of the frictional sheets 112a.

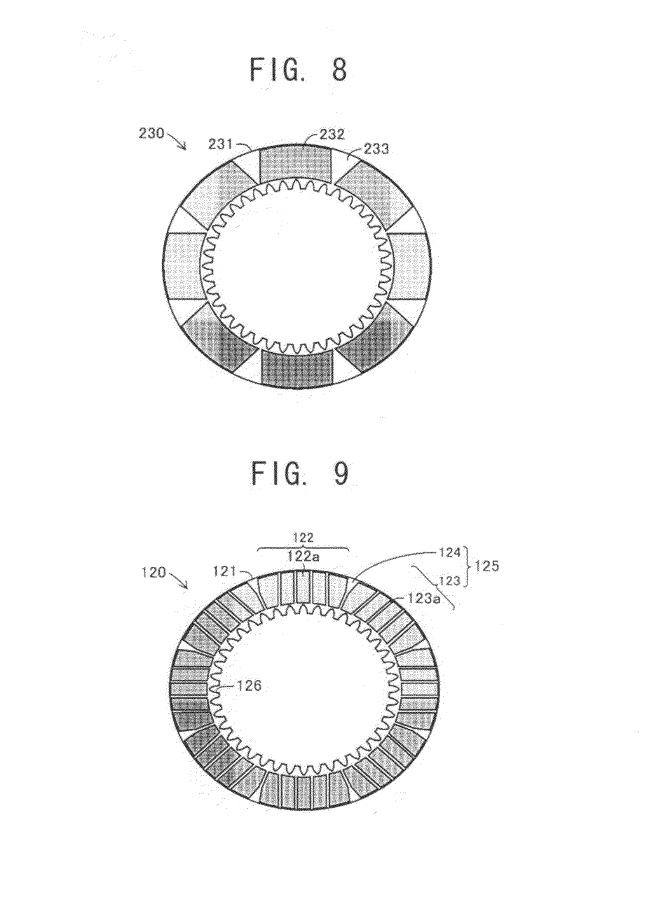

FIG. 7 shows the results of another experiment conducted by the present inventors in order to confirm the effect attained by providing the small-groove groups 112 on the clutch friction plates 110. The graph shows the ratio of the increase or decrease in drag torque (Nm) in the case where clutch friction plates 230 having no small groove were used and the case where clutch friction plates 110 having the small grooves 112 were used. In the graph, the drag torque produced in the case where the conventional clutch friction plates 200 were used is shown as a reference. As shown in FIG. 8, clutch friction plates 230 are configured such that eight frictional sheets 232 having a generally rectangular shape extending in the circumferential direction of a metal core 231 are arranged in the circumferential direction of the metal core 231, with fan-shaped grooves 233 formed between them. In this case, the size of the frictional sheets 232 of the clutch friction plate 230 is equal to the size covering the frictional sheets 112a and the small grooves 113a in each group in the clutch friction plate 110 of the present invention. Also, the size of the oil grooves 233 of clutch friction plate 230 is equal to the size of the fan-shaped grooves 114 of the clutch friction plate 110 of the present invention.

The results of the experiment shown in FIG. 7 demonstrate that the clutch friction plate 110 of the present invention can reduce drag torque by about 40% compared with clutch friction plate 200 (reference), and the drag torque of the clutch friction plate 230 having no small groove is about 5% greater than that of clutch friction plate 200. That is, the clutch friction plate 110 of the present invention can be said to realize the reduction of drag torque by a synergistic effect produced as a result of the oil grooves 115 being formed by the small-groove groups 113 and the fan-shaped grooves 114.

As can be understood from the above description of operation, according to the above-described embodiment, the clutch 100, which includes the clutch friction plates 110, the clutch plates 103, and clutch oil, is characterized in that each clutch friction plate 110 has the small-groove groups 113 and the fan-shaped grooves 114 provided on the flat annular metal core 111 thereof. Each small-groove group 113 is composed of the plurality of small grooves 113a having a width which is smaller than the width of the fiction material sheets measured in the circumferential direction of the metal core 111. Each fan-shaped groove 114 is disposed adjacent to the corresponding small-groove group 113 in the circumferential direction of the metal core 111 and increases in width from the inner peripheral side toward the outer peripheral side of the metal core 111. When the clutch friction plates 110 of the clutch 100 are rotated, the clutch oil present on the inner peripheral side of the metal core 111 is led from the inner peripheral side to the outer peripheral side of the metal core 111 through the small-groove groups 113 and the fan-shaped grooves 114. By virtue of this configuration, as described above, the clutch of the present invention can further reduce drag torque compared with a clutch which uses a conventional clutch friction plate (clutch friction plate 220) in which the outer corner portions of the small frictional sheets provided on the surface of the clutch friction plate are rounded (curved) or chamfered. This has been proved by an experiment performed by the present inventors.

The present invention is not limited to the above-described embodiment, and it may be modified in various ways without departing from the scope of the present invention. In modifications described below, structural portions identical with those of the clutch friction plate 110 according to the above-described embodiment are denoted by the same reference numerals as those used for clutch friction plate 110, and their descriptions will not be repeated.

In the above-described embodiment, the fan-shaped grooves 114 of each clutch friction plate 110, which serve as the oil grooves 115, are formed such that their width increases from the innermost end toward the outer end (with respect to the radial direction) of the metal core 111. However, the present inventors found through an experiment that drag torque can be reduced substantially if the fan-shaped grooves 114 extend from the innermost end (with respect to the radial direction) toward the outer end (with respect to the radial direction) of the metal core 111, and the width of the fan-shaped grooves 114 increases toward the outer end of the metal core 111 from a point in a range between the innermost end and approximately midway between the innermost end and the outermost end with respect to the radial direction. For example, FIG. 9 shows a clutch friction plate 120 having fan-shaped grooves 124 which extend outward from the innermost end of the metal core 111 and which have a width which increases toward the outer end of the metal core 111 from approximately midway between the innermost end and the outermost end with respect to the radial direction. The present inventors found through an experiment that the clutch friction plate 120 shown in FIG. 9 can reduce drag torque by about 20% compared with the drag torque of the clutch friction plate 200 (reference). The results of the experiment demonstrate that the effect of reducing the drag torque may increase with the amount by which the width of the fan-shaped grooves 114 is increased from the innermost end toward the outer end of the metal core 111.

In the above-described embodiment, by radially disposing eight friction sheet groups 112 at substantially equal intervals in the circumferential direction of the metal core 111, eight small-groove groups 113 and eight fan-shaped grooves 114 are provided on the metal core 111. However, the number of small-groove groups 113 and the number of fan-shaped grooves 114 are not limited to those employed in the above-described embodiment, and may be 7 or less, or 9 or greater. The present inventors found through an experiment that the number of small-groove groups 113 and the number of fan-shaped grooves 114 are preferably 5 to 10.

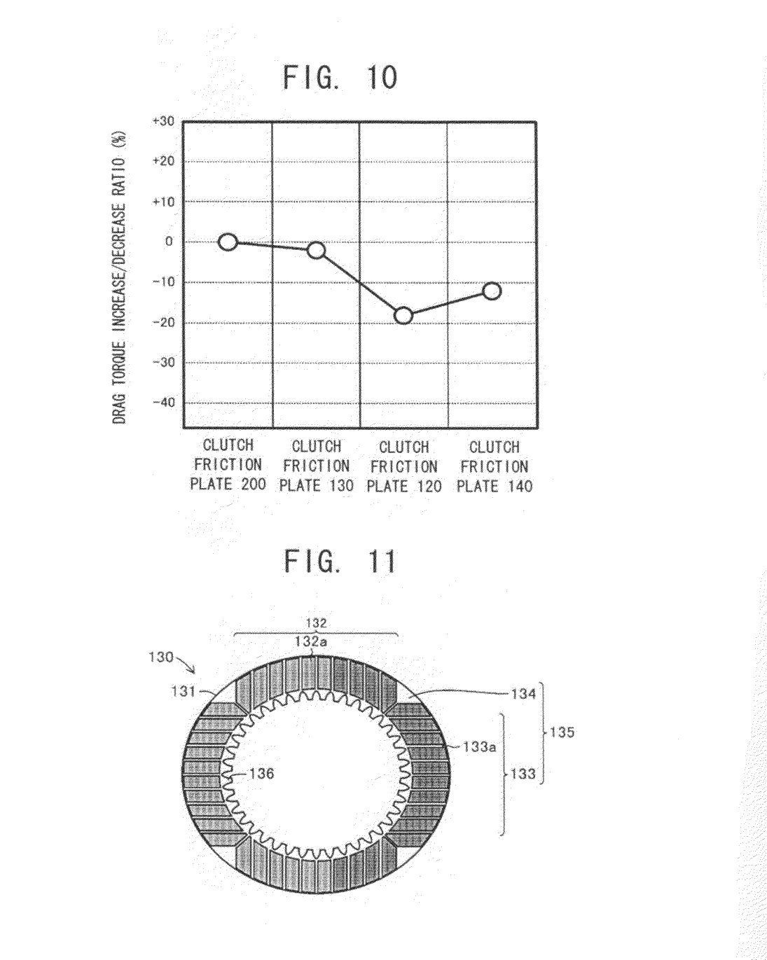

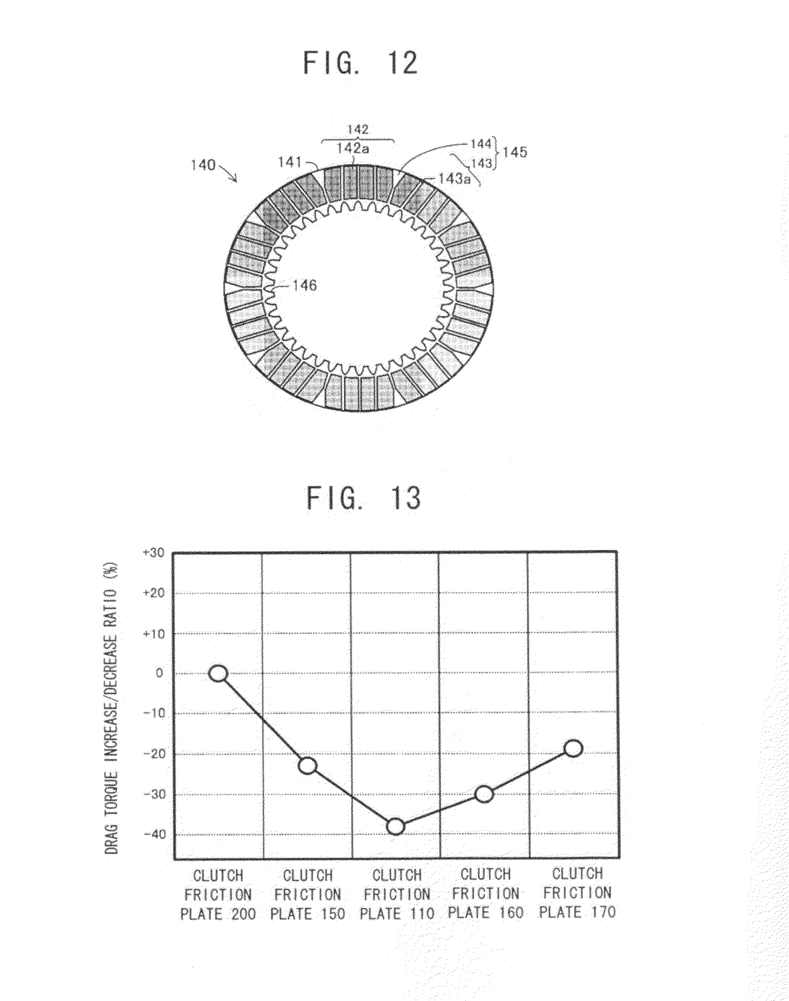

FIG. 10 is a graph showing the results of the experiment carried out by the inventors. The graph shows the ratio of the increase or decrease in drag torque (Nm) in the case where clutch friction plates 130 each having four small-groove groups 133 and four fan-shaped grooves 134 were used, the case where clutch friction plates 120 each having eight small-groove groups 123 and eight fan-shaped grooves 124 were used, and the case where clutch friction plates 140 each having ten small-groove groups 143 and ten fan-shaped grooves 144 were used. In the graph, the drag torque produced in the case where the conventional clutch friction plates 200 were used is shown as a reference. As shown in FIG. 11, each clutch friction plate 130 has four small-groove groups 133 and four fan-shaped grooves 134. As shown in FIG. 12, each clutch friction plate 140 has ten small-groove groups 143 and ten fan-shaped grooves 144. Each fan-shaped groove 134 (124, 144) extends outward from the innermost end of the metal core 131 (121, 141), and its width increases toward the outer end of the metal core 131 (121, 141) from approximately midway between the innermost end and the outermost end with respect to the radial direction.

The results of the experiment shown in FIG. 10 demonstrate that the clutch friction plate 130 can reduce drag torque slightly compared with the conventional clutch friction plate 200 (reference), and the clutch friction plates 120 and 140 can reduce drag torque by about 20% and about 10%, respectively, compared with the conventional clutch friction plate 200. It is considered from the results that the number of small-groove groups 113 and the number of fan-shaped grooves 114 provided on the metal core 111 are preferably set to 5 to 10 and are more preferably set to 8.

In the above-described embodiment, each small-groove group 113 includes four small grooves 113a formed by five frictional sheets 112a. However, the number of small grooves 113a of each small-groove group 113 is not limited to the number employed in the above-described embodiment, and it may be 3 or less or 5 or grater. The inventors found through an experiment that the number of small grooves 113a of each small-groove group 113 is preferably 4 or 5.

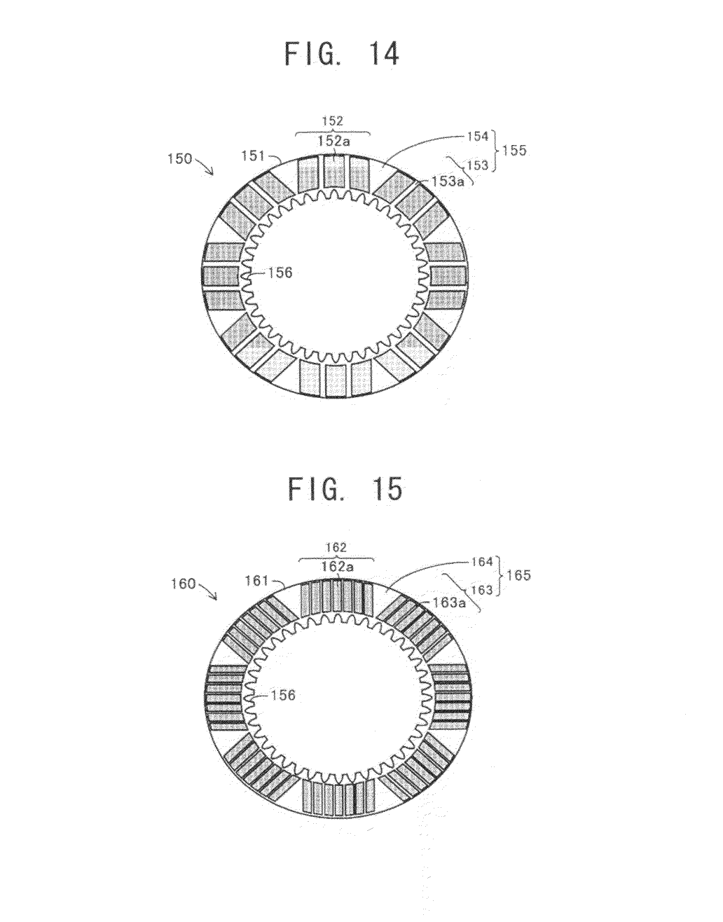

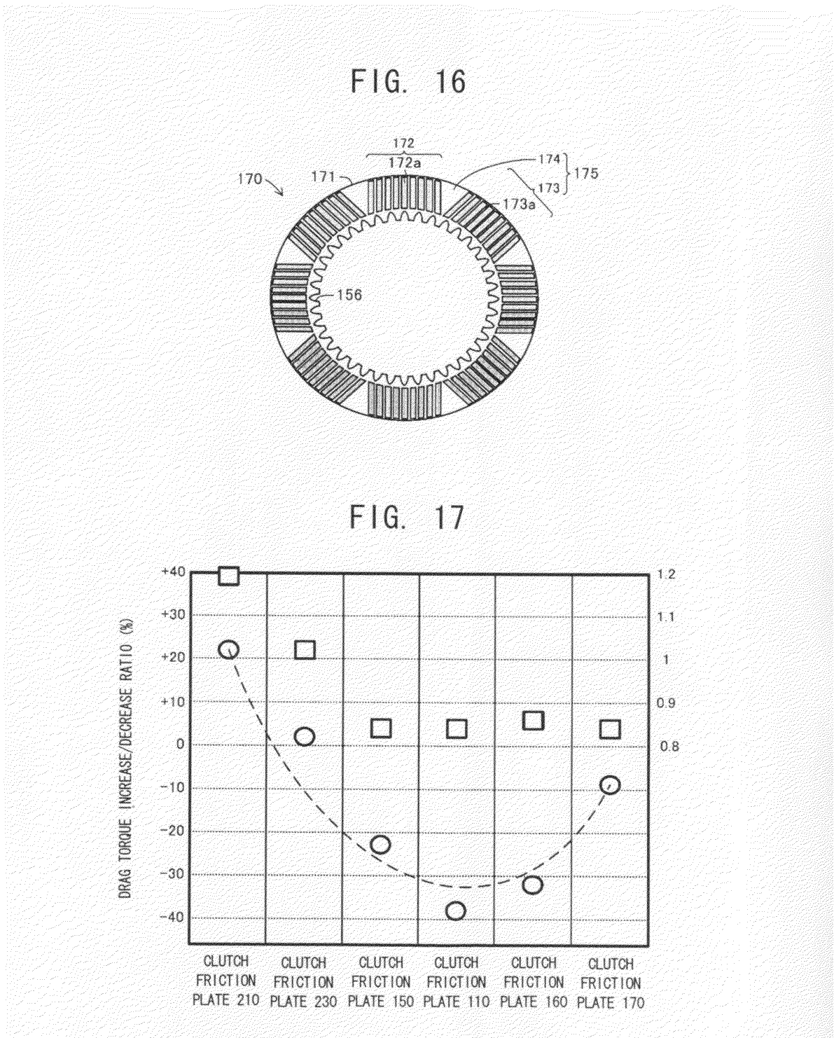

FIG. 13 is a graph showing the results of the experiment carried out by the inventors. The graph shows the ratio of the increase or decrease in drag torque (Nm) in the case using clutch friction plates 150 having small-groove groups 153 each composed of two small grooves 153a, the case using clutch friction plates 110 having small-groove groups 113 each composed of four small grooves 113a, the case using clutch friction plates 160 having small-groove groups 163 each composed of six small grooves 163a, and the case using clutch friction plates 170 having small-groove groups 173 each composed of eight small grooves 173a. In the graph, the drag torque produced in the case using the conventional clutch friction plates 200 is shown as a reference. As shown in FIG. 14, each clutch friction plate 150 has small-groove groups 153 each composed of two small grooves 153a. As shown in FIG. 15, each clutch friction plate 160 has small-groove groups 163 each composed of six small grooves 163a. As shown in FIG. 17, each clutch friction plate 170 has small-groove groups 173 each composed of eight small grooves 173a.

The results of the experiment shown in FIG. 13 demonstrate that the clutch friction plate 150 configured such that each small-groove group 153 includes two small grooves 153a and the clutch friction plate 170 configured such that each small-groove group 173 includes eight small grooves 173a can reduce drag torque by about 20%, and the clutch friction plate 160 configured such that each small-groove group 163 includes six small grooves 163a can reduce drag torque by about 30%. The results also show that the clutch friction plate 110 configured such that each small-groove group 113 includes four small grooves 113a can reduce drag torque by about 40%. It is considered from the results that the number of the small grooves 113a of each small-groove group 113 is preferably set to 2 to 8 and more preferably 4 to 6.

FIG. 17 is a graph showing the drag torque increase or decrease ratios (circular marks) of the clutch friction plates 210, 230, 150, 110, 160, and 170, and the total areas (square marks) of the respective frictional sheets 212, 232, 152a, 112a, 162a, 172a of the clutch friction plates 210, 230, 150, 110, 160, and 170. The graph of FIG. 17 demonstrates that the clutch friction plates 150, 110, 160, and 170 greatly differ from one another in drag torque increase or decrease ratio although their frictional sheets 152a, 112a, 162a, and 172a are substantially identical. This also demonstrates that, as described above, the magnitude of the drag torque depends not only on the total area of the frictional sheets provided on each clutch friction plate, but also on the shape and positions of the frictional sheets and the shape and positions of the oil grooves, which are defined by the shape and positions of the frictional sheets.

In the above-described embodiment, the end portions of the small grooves 113a of each small-groove group 113 located on the inner peripheral side of the metal core 111 are located on a common circle. However, the inventors found through an experiment that the drag torque reduction effect can be enhanced by forming the small grooves 113a of each small-groove group 113 such that the positions of their ends on the inner peripheral side of the metal core 111 are alternatingly shifted in the radial direction.

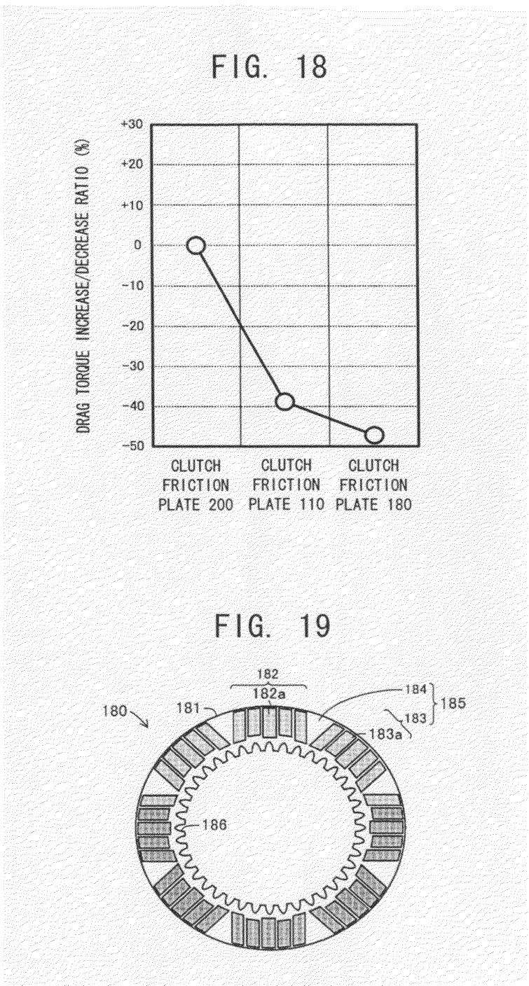

FIG. 18 is a graph showing the results of the experiment carried out by the inventors. The graph shows the ratio of the increase or decrease in drag torque (Nm) in the case where the clutch friction plates 110 of the above-described embodiment were used and the case where clutch friction plates 180 were used. In the graph, the drag torque produced in the case where the conventional clutch friction plates 200 were used is shown as a reference. As shown in FIG. 19, the clutch friction plates 180 are configured such that the end portions of four small grooves 183a of each small-groove group 183 located on the inner peripheral side of a metal core 181 are staggered in the circumferential direction of the metal core 111, whereby the end portions of the small grooves 183a adjacent to each other are shifted from each other in the radial direction of the metal core 181.

The results of the experiment shown in FIG. 18 demonstrate that clutch friction plate 180 can reduce drag torque by about 50% compared with clutch friction plate 200 (reference), i.e., clutch friction plate 180 has a drag torque decrease ratio greater than that of clutch friction plate 110 of the above-described embodiment.

In the above-described embodiment, the clutch 100 includes a plurality of clutch plates 103 and a plurality of clutch friction plates 110. However, the structure of the clutch 100 is not limited to that of the above-described embodiment, and the clutch 100 is merely required to include at least one clutch plate 103 and at least one clutch friction plate 110.

### DESCRIPTION OF REFERENCE NUMERALS

100 . . . clutch, 101 . . . housing, 102 . . . input gear, 103 . . . clutch plate, 104 . . . friction plate holder, 105 . . . shaft, 106 . . . push rod, 107 . . . pressing force-applying cover, 110 . . . clutch friction plate, 111 . . . metal core, 112 . . . friction sheet group, 112a . . . frictional sheet, 113 . . . small-groove group, 113a . . . small groove, 114 . . . fan-shaped groove, 115 . . . oil groove, 116 . . . spline.

1-9. (canceled)

10. A clutch comprising:
a clutch friction plate comprising a flat annular metal core and a plurality of frictional sheets and a plurality of oil grooves provided on a surface of the metal core, the oil grooves being formed by spaces between the frictional sheets and extending from an inner peripheral side to an outer peripheral side of the metal core, the oil grooves including small-groove groups comprising a plurality of small grooves having a width smaller than a width of the frictional sheets measured in a circumferential direction of the metal core, and fan-shaped grooves each disposed adjacent to a corresponding small-groove group in the circumferential direction of the metal core and having a width which increases from the inner peripheral side toward the outer peripheral side of the metal core;
a flat annular clutch plate which is pressed against or separated from the frictional sheets of the clutch friction plate; and
clutch oil supplied to a space between the clutch friction plate and the clutch plate, wherein when the clutch friction plate rotates, the clutch oil present at the inner peripheral side of the metal core is led to the outer peripheral side of the metal core through the small-groove groups and the fan-shaped grooves so as to reduce drag torque produced between the clutch friction plate and the clutch plate.

11. A clutch as claimed in claim 10 wherein the clutch friction plate has 5-10 small-groove groups in the circumferential direction of the metal core and 5-10 fan-shaped grooves in the circumferential direction of the metal core.

12. A clutch as claimed in claim 10 wherein each small-groove group has 4-6 small grooves.

13. A clutch as claimed in claim 10 wherein end portions of the small grooves of each small-groove group located on the inner peripheral side of the metal core are staggered such that the end portions of small grooves adjacent to each other are shifted from each other in a radial direction of the metal core.

14. A method of operating the clutch of claim 10 comprising rotating the clutch friction plate of the clutch to lead clutch oil present at the inner peripheral side of the metal core to the outer peripheral side through the small-groove groups and the fan-shaped grooves.

15. A clutch friction plate comprising a flat annular metal core and a plurality of frictional sheets and a plurality of oil grooves provided on a surface of the metal core, the oil grooves being formed by spaces between the frictional sheets and extending from an inner peripheral side to an outer peripheral side of the metal core, the oil grooves including small-groove groups comprising a plurality of small grooves having a width smaller than a width of the frictional sheets measured in a circumferential direction of the metal core, and fan-shaped grooves each disposed adjacent to a corresponding small-groove group in the circumferential direction of the metal core and having a width which increases from the inner peripheral side toward the outer peripheral side of the metal core.
